(19) United States
(12) Patent Application Publication
(10) Pub. No.: US 2018/0317402 A1
(43) Pub. Date: Nov. 8, 2018

(54) Mushroom Cultivation Device and Methods of Cultivation

(71) Applicant: Hendrik Van den Top, Barneveld (NL)

(72) Inventors: Hendrik Van den Top, Barneveld (NL); Bart Jan Van den Top, Barneveld (NL)

(21) Appl. No.: 15/774,106

(22) PCT Filed: Nov. 7, 2016
(86) PCT No.: PCT/NL2016/050777

§ 371 Date: May 7, 2018

(30) Foreign Application Priority Data
Nov. 5, 2015 (NL) 2015733

(51) Int. Cl. A01G 18/62

(52) U.S. Cl. CPC A01G 18/62

(57) ABSTRACT

The present invention relates to a mushroom cultivation rack. The rack is generally constructed from a number of uprights arranged vertically during use. A girder extends from each upright in transverse direction thereof to the opposite side of the rack. Situated transversely of girders in the longitudinal direction of the rack are carriers or spanning members. The spanning members support substrate holders for holding substrate in which the mycelium of the mushrooms is raised.

The present invention relates to a mushroom cultivation rack. The present invention also relates to a method for using such a mushroom cultivation rack. The present invention further relates to a method for manufacturing a mushroom cultivation rack.

The present invention improves the prior art by means of a mushroom cultivation rack for cultivating mushrooms by means of a substrate, such as a compost, to be held by the rack, comprising:
uprights for providing a support to the rack relative to a ground surface,
girders for providing a support for spanning members,
spanning members for spanning a mutual distance between girders,

wherein the mushroom cultivation rack is preferably manufactured by means of a method for manufacturing the uprights, girders and/or spanning members from at least one base material and assembling thereof while applying only operations such as cutting, shearing, punching and folding, preferably in an automated process.

It is an advantage of such a rack that it can be manufactured in simple manner to form a construction kit by means of manufacturing the separate uprights, girders and spanning members from the base material, after which the rack can be assembled in simple manner on the basis of the construction kit. Much in-situ assembly work is hereby avoided.

According to a preferred embodiment, the at least one base material is a prefabricated sheet material with a metallic alloy as coating.

For further embodiments the mushroom cultivation rack comprises medium conduits for cooling and/or heating. The temperature of the substrate can hereby be controlled by means of a cooling medium or a heating medium. Spanning members are more preferably configured to cool and/or heat the substrate. The medium conduits are more preferably arranged in or on one or more of the spanning members.

According to a further preferred embodiment, the spanning members are arranged in the longitudinal direction of a rack. It hereby becomes possible in simple manner to displace and/or slide substrate over the spanning members. For this purpose the spanning members more preferably function as direct carrier of the substrate. According to a preferred embodiment in which the spanning members comprise a guide surface, the substrate can be supplied and discharged in sliding manner thereover.

The mushroom cultivation rack more preferably also comprises side panels, such as edging boards, for supporting the girders opposite an upright. In advantageous manner the side panels are suitable here for supporting at least a harvesting machine and/or a substrate working machine.

The spanning members in the mushroom cultivation rack preferably comprise a placing profile with upper surface for carrying the substrate and an interior inner space arranged under the upper surface for carrying the at least one medium conduit.

The spanning members are more preferably suitable for receiving support members for supporting the at least one medium conduit, which support members are preferably embodied as a profile.

The spanning members more preferably comprise engaging means for engaging thereon of a clamp for holding the at least one medium conduit and/or the support members in upward orientation.

The girders are more preferably provided with throughfeed channels or slots for feeding therethrough or arranging therein what is an underside of the spanning members during use.

The girders are more preferably provided with hook means for hooking onto docking means of the uprights, which hook means and/or docking means are preferably manufactured by means of a cutting operation from the base material.

The coating of the material of the side panels is more preferably manufactured so as to withstand a wear load from the machines.

A further aspect of the present invention relates to a method for using a mushroom cultivation rack according to one or more of the foregoing claims, comprising steps for:
providing the mushroom cultivation rack,
supplying the substrate to the rack from a side of the rack over the longitudinal direction of the spanning members by means of a suitable transport medium such as a net or a geotextile,
performing a substrate-related growing and harvesting cycle making use of the substrate,
discharging the substrate from the rack from a side of the rack over the longitudinal direction of the spanning members by means of a suitable transport medium such as the net or the geotextile.

A growing and harvesting cycle can be performed in simple manner by means of such a method.

A further aspect of the present invention relates to a method for manufacturing a mushroom cultivation rack while applying only operations such as cutting, shearing, punching and folding, preferably in an automated process, more preferably while applying a prefabricated sheet material with a metallic alloy as coating.

Further advantages, features and details of the present invention will be described in greater detail hereinbelow on the basis of one or more preferred embodiments with reference to the accompanying figures. Similar, though not necessarily identical components of different preferred embodiments are designated with the same reference numerals.

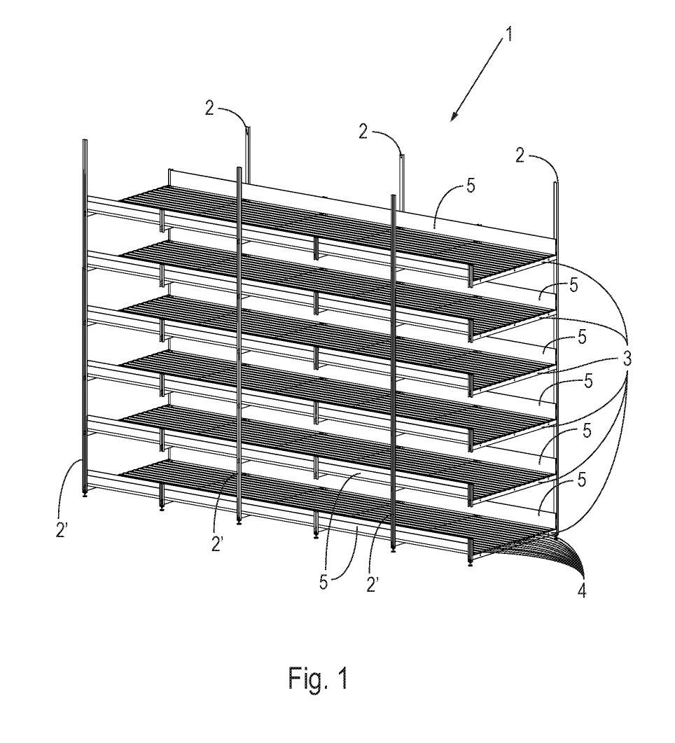

FIG. 1 is a schematic perspective view of a first preferred embodiment according to the present invention.

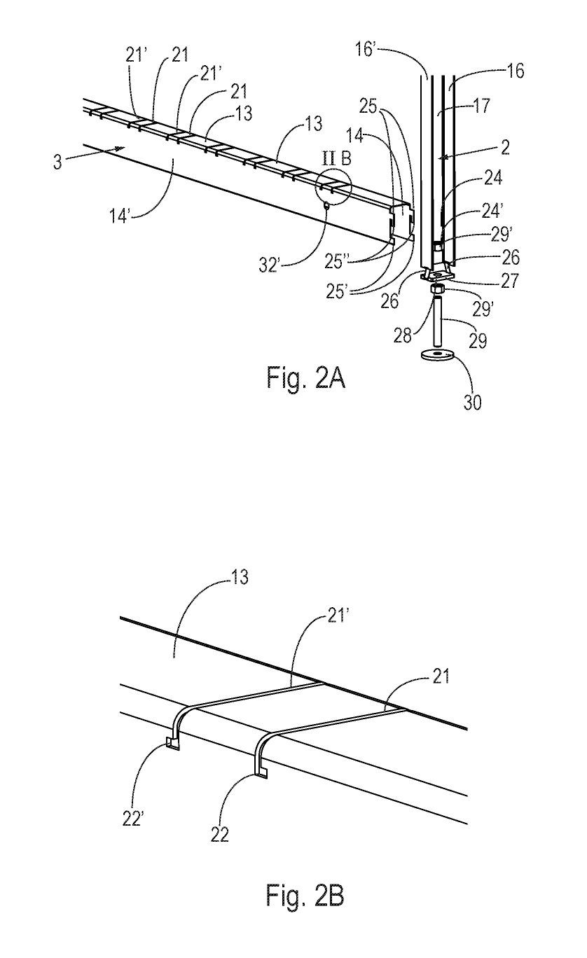

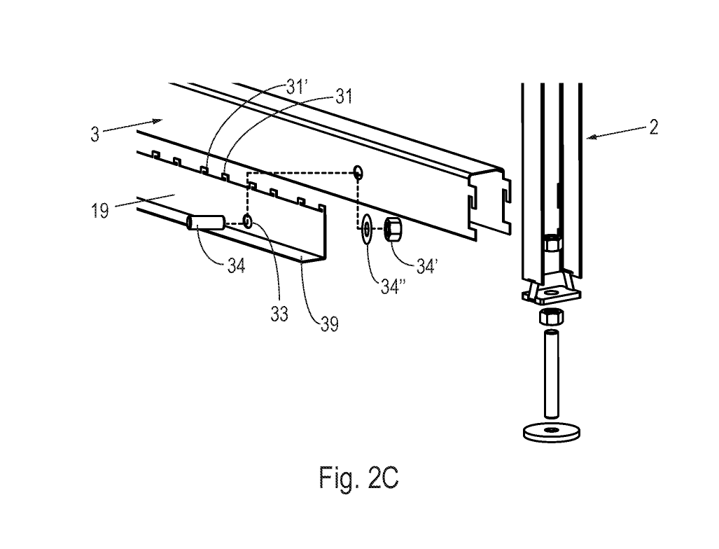

FIG. 2 is a perspective view of a detail of the preferred embodiment according to FIG. 1 and according to a further preferred embodiment.

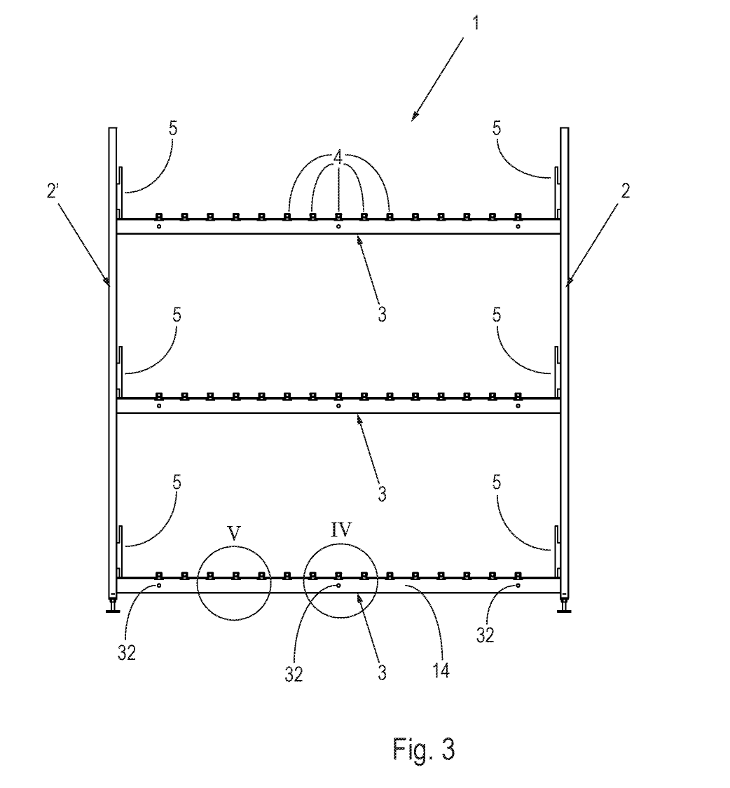

FIG. 3 is a side view of the preferred embodiment according to FIG. 1.

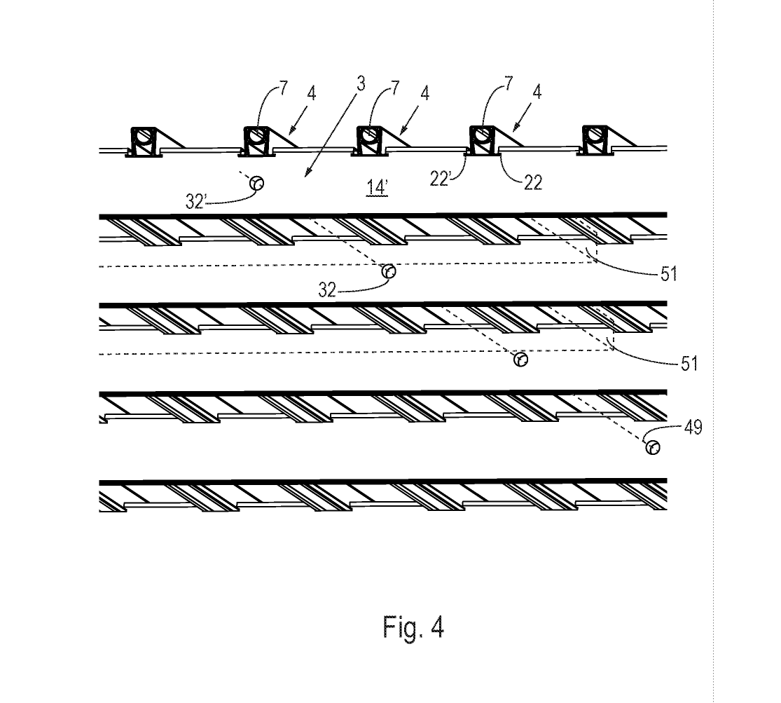

FIG. 4 is a perspective view of a detail of the preferred embodiment according to FIG. 1.

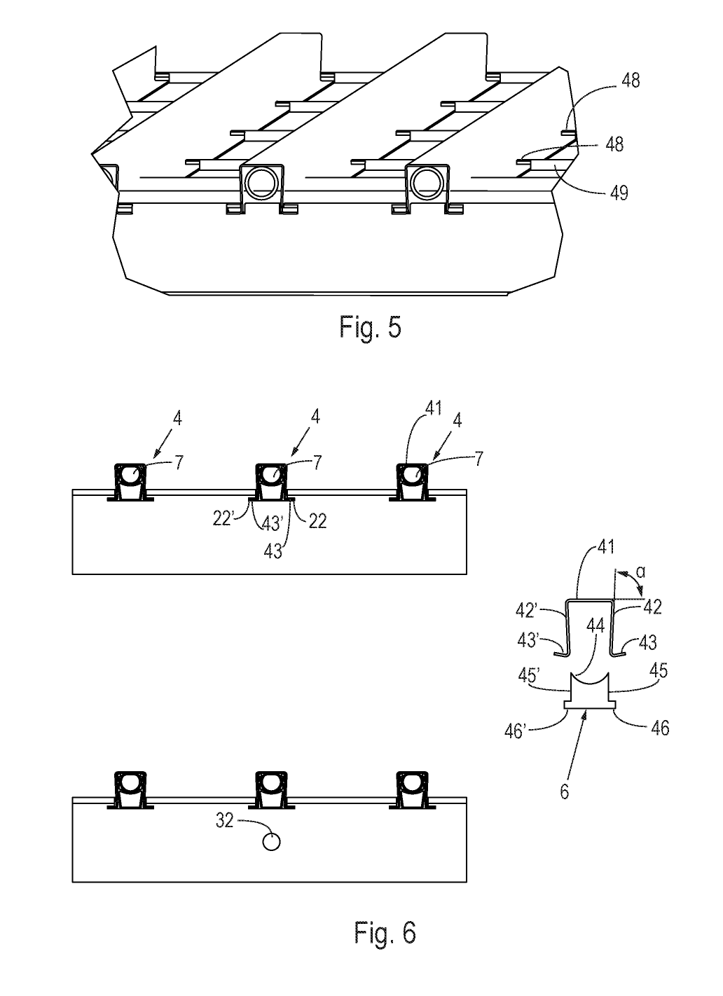

FIG. 5 is a perspective view of a detail of the preferred embodiment according to FIG. 1.

FIG. 6 shows side views of further details of the preferred embodiment according to FIG. 1.

A first preferred embodiment (FIG. 1) according to the present invention relates to a mushroom cultivation rack 1. This is generally constructed from a number of uprights 2 arranged vertically during use and mutually connected by means of edging boards 5. A girder 3 extends from each upright in transverse direction thereof to the opposite side of the rack. This rack is a so-called zigzag rack with uprights alternately on one side and on the other side of the rack. As shown, a girder therefore makes contact with an upright on one side of the rack. Provided in alternative manner according to this invention are more regular racks wherein two uprights are always connected at each position to a girder.

This zigzag rack according to FIG. 1 is suitable for applying a harvesting machine which discharges mushrooms alternately on either side during harvesting. Such a harvesting machine has already been disclosed in a separate patent application by the present inventor. An envisaged length of such racks ranges from several metres to several tens of metres.

Situated transversely of girders 3 in the longitudinal direction of the rack are carriers or spanning members 4. These support substrate holders (not shown) for holding substrate in which the mycelium of the mushrooms is raised.

An important aspect of the present invention is that supporting elements of the rack, such as uprights 2, girders 3, carriers 4 and/or edging boards 5, are preferably manufactured from a prefabricated sheet material, preferably of sheet steel, more preferably comprising carbon, with a metallic coating arranged during a prefabrication process. This metallic coating preferably comprises zinc, aluminium and/or magnesium in an alloy.

More than 80% zinc, preferably more than 90% zinc, more preferably more than 93% zinc, more preferably substantially 93.5% zinc is preferably incorporated here. The amount of aluminium is more preferably between 2 and 6%, more preferably between 2.5 and 5%, more preferably between 3 and 4%, more preferably 3.5%. The amount of magnesium is more preferably between 1 and 5%, more preferably between 2 and 4% and more preferably substantially 3%. During the manufacture of the sheet material use is preferably made of a galvanizing process, more preferably a galvanizing process wherein the sheet steel is immersed in the alloy. A protected name of such a material is known as ZMA.

It is envisaged that the uprights, girders, spanning members, side panels, support members are preferably manufactured by means of the prefabrication described. In other words, preferably all metal components of the rack are produced in advance from the base material.

The material, in particular the coating, preferably has a self-healing property when edges are cut. The material more preferably has a high corrosion-resistance in an atmosphere with acids and bases, more preferably in an atmosphere with chloride and ammonia.

During manufacture of uprights 2, girders 3, carriers 4 and/or edging boards 5 use is preferably made of only cutting operations and/or punching operations in combination with folding operations, such as preferably a continuous folding process. A significant advantage of applying said cutting operations and punching operations in combination with the folding operations is that the manufacture of such supporting elements can take place in a substantially automated process. Passage of the sheet material through this process of cutting, punching and folding in the automated manner provided by the inventor provides a significant efficiency advantage in the manufacturing method. The inventor began development of this method of production on the basis of the desire for efficiency improvement during production making use of components fabricated from steel or sheet steel which then had to be galvanized for use in the mushroom cultivation rack. Initial manufacture and subsequent galvanization require a high degree of logistics management and handling of material. A further drawback of the prior art with galvanized components was that, following a galvanizing step, time-consuming finishing operations are required to remove zinc residues, such as beads or clogged holes.

Application of said prefabricated material in the new automated method provides a number of advantages. An advantage of such a prefabricated material is that during cutting or punching the cut edges are protected by the alloy being drawn thereover. Following cutting or punching the steel is hereby protected by this alloy from corrosion without further galvanization as according to the prior art being necessary.

During the manufacture of a mushroom cultivation rack according to the invention the whole operational process is therefore more preferably based on cutting operations, punching operations and folding operations. Processes which make processing steps for preventing corrosion necessary are excluded from the process. Making openings and holes is preferably carried out according to the present invention only by means of cutting and punching. The creation of mutual connections between material by means of such openings and holes is provided for by means of bolts and nuts. It is for instance envisaged here according to a preferred embodiment that the edging boards are attached by means of bolts and nuts and respective openings and holes to the uprights in order to impart rigidity to the rack.

As shown in FIG. 2, the upright is constructed from a substantially U-shaped profile with an end wall 17 and two side walls 16, 16′. Preferably further provided is a folded portion in the ends of the ‘U’. Provided in the end wall 17 are support openings 24, 24′ for supporting a respective girder 3.

Girder 3 has for this purpose protruding elements 25, 25′ for insertion thereof into support openings 24, 24′ of the upright. The two upper protruding elements 25 have a downward extending engaging part 25″. The lower protruding elements 25′ have a shorter downward extending part such that they do not extend beyond the underside of the profile of girder 3, this for the purpose of preventing dam-age thereto.

Girder 3 likewise has a substantially U-shaped profile with an end wall 13 and two legs 14, 14′. For the purpose of supporting and positioning the carriers 4 the end wall 13 has a number of pairwise slots 21, 21′ which connect to horizontally extending receiving openings 22, 22′. These slots with receiving openings are arranged by means of a punching operation in the sheet material before it is folded to form the U-profile. The girder is also provided with passage openings 32, 32′ in respective side walls 14, 14′. These passage openings serve for passage of a wire or rod 49 allowing an insulating plate 51 to rest thereon (FIG. 4). The girder is provided in alternative manner with an attachment profile 19 attached to the outer side of the girder. This attachment profile has two functions. The first function is to provide a support edge 39 for said insulating plate 51 instead of wire 52. The second function is to provide positioning by means of positioning elements 31, 31′. Attachment profile 19 is fixed to the girder by means of a bolt 34, nut 34′ and an opening 33.

Carriers 4 are formed by means of a substantially U-shaped profile with an end wall 41 and legs 42, 42′ extending therefrom. Folded edges 43, 43′ extend from legs 42, 42′ in order to provide strength. Walls 42, 42′ are folded relative to end wall 41 at an angle α, such as preferably an angle of 1 to 15° smaller than a right angle, such as preferably an angle of 85 to 88°. Hereby realized according to the present embodiment is that a support element 6 can be arranged between side walls 42, 42′ in a manner such that it is prevented from dropping out in downward direction. Support element 6 has side edges 45, 45′ at an angle corresponding to that of side walls 42, 42′. Support element 6 also has a support edge 44 for supporting for instance a hose or a tube. Support element 6 also has a stop 46, 46′ for suitable positioning of the support element relative to carrier 4 of the rack. An alternative attachment of such a hose or tube is provided in the form of holes 32, 32′ for passage of a wire 49 therethrough.

A further aspect according to the present invention relates to a throughflow member 7, preferably embodied as a hose or a tube, for a heating medium or a cooling medium. During use of the described carrier 4 and support element 6 it is important that throughflow member 7 can be held in advantageous manner arranged against end wall 41 of the carrier. This is particularly important in the case of cooling for the purpose of realizing a suitable thermal contact, since during cooling the heat must move downward, this taking place best with direct contact. The upward transport in the case of heating is relatively easy.

Insulating plate 51 provides for insulation between the levels of the rack and, in the case of cooling, pre-vents dripping of condensation droplets onto the crop.

It is further envisaged, for the purpose of providing a greater measure of cooling of the centre of the substrate, to provide spanning members at a shorter mutual distance at the centre of the rack in order to enable a greater number of throughflow members per unit length of the girder. An advantage of applying a tube or hose is that it can be inserted in simple manner after construction of the rack.

The base of the rack is formed by a support plate 27 which is attachable to the upright by means of folding two fixing tongues 26, 26′. Support plate 27 has a threaded opening 28 for a threaded end 29 with a matching nut 29′ for securing purposes. Threaded end 29 is provided on the underside with a protective cap 30.

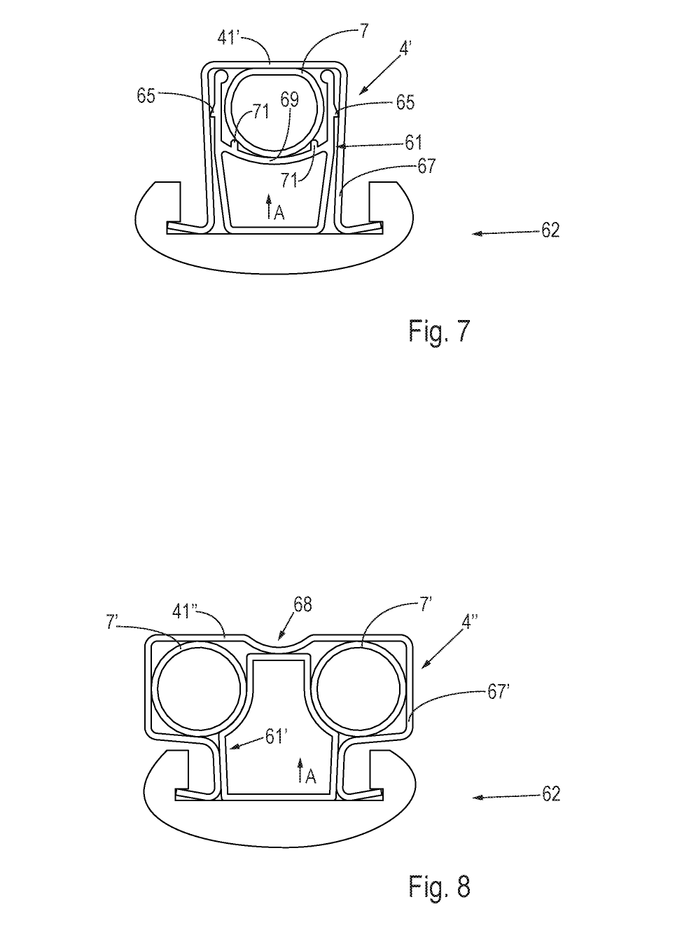

Shown in FIG. 7 is a further variant of a spanning member 4′. This comprises an outer profile 67 with an upper surface 41′ for carrying the substrate. For the purpose of cooling the substrate spanning member 4′ comprises a hose 7 suitable for throughflow of cooling agent. This hose is pressed in upward direction in the direction of arrow A with a substantially flat contact surface against the underside of surface 41′. This contact surface enhances downward discharge of heat from the substrate in the direction of the cooling agent in hose 7.

Pressing in upward direction takes place by means of a pressing profile 61 which is provided with a pressing surface 69 suitable for the purpose with two pressing protrusions 71. Pressing profile 61 is held clamped in upward direction by means of clamps 62. Pressing profile 61 more preferably makes contact with the girders for support of the pressing profile by the girders. Profile 61 has on either side a nose 65 for reducing the contact surface area with profile 67. This creates a cold bridge.

Shown in FIG. 8 is a further variant of spanning member 4″. Two hoses 7′ are placeable herein which are supported by a combination of an internal support surface of profile 67′ and a pressing profile 61′. These hoses also serve for cooling and/or heating of the substrate. These hoses can preferably also be pressed in order to form a contact surface with the underside of upper surface 41″. The upper surface of profile 67′ has a recess 68 for reducing contact with the substrate or the net or geotextile supporting the substrate, preferably for the purpose of easy displacement thereof over this surface.

Clauses

1. Method for manufacturing components for a mushroom cultivation rack, such as preferably structural elements such as an upright, a girder and a spanning member, while applying a steel sheet which by means of prefabrication is provided with a coating, preferably a metallic coating preferably with wear-resistant and corrosion-resistant properties, more preferably comprising an alloy comprising zinc, aluminium and magnesium as according to the present description.

2. Method according to clause 1, comprising processing steps for manufacturing such as punching, shearing, cutting and folding.

The present invention has been described in the foregoing on the basis of several preferred embodiments. Different aspects of different embodiments are deemed described in combination with each other, wherein all combinations which can be deemed by a skilled person in the field as falling within the scope of the invention on the basis of reading of this document are included. These preferred embodiments are not limitative for the scope of protection of this document. The rights sought are defined in the appended claims.

1. A mushroom cultivation rack for cultivating mushrooms by means of a substrate to be held by the rack, comprising:
uprights for providing a support to the rack relative to a ground surface,
girders for providing a support for spanning members, and
the spanning members for spanning a mutual distance between girders,
wherein the mushroom cultivation rack is manufactured by a method for manufacturing the uprights, girders and/or spanning members from at least one base material and assembling thereof.

2. The mushroom cultivation rack as claimed in claim 1, wherein the at least one base material is a prefabricated sheet material with a metallic alloy as coating.

3. The mushroom cultivation rack as claimed in claim 1, comprising medium conduits for cooling and/or heating.

4. The mushroom cultivation rack as claimed in claim 1, wherein the spanning members are configured to cool and/or heat the substrate.

5. The mushroom cultivation rack as claimed in claim 3, wherein the medium conduits are arranged in or on one or more of the spanning members.

6. The mushroom cultivation rack as claimed in claim 1, wherein the spanning members are arranged in a longitudinal direction of a rack.

7. The mushroom cultivation rack as claimed in claim 1, wherein the spanning members function as a direct carrier of the substrate.

8. The mushroom cultivation rack as claimed in claim 1, wherein the spanning members comprise a guide surface for adding and discharging the substrate in sliding manner thereover.

9. The mushroom cultivation rack as claimed in claim 1, comprising side panels for supporting the girders opposite an upright.

10. The mushroom cultivation rack as claimed in claim 9, wherein the side panels are suitable for supporting at least a harvesting machine and/or a substrate working machine.

11. The mushroom cultivation rack as claimed in claim 1, wherein the at least one base material comprises sheet steel with a metallic coating arranged during a prefabrication process.

12. The mushroom cultivation rack as claimed in claim 11, wherein the metallic coating comprises zinc, aluminium and/or magnesium.

13. The mushroom cultivation rack as claimed in claim 12, wherein the coating comprises more than 80% zinc, wherein the amount of aluminium is between 2 and 6%, wherein the amount of magnesium is between 1 and 5%.

14. The mushroom cultivation rack as claimed in claim 11, wherein the sheet material is provided with the coating by means of a galvanizing process.

15. The mushroom cultivation rack as claimed in claim 1, wherein the spanning members comprise a placing profile with upper surface for carrying the substrate and an interior inner space arranged under the upper surface for carrying the at least one medium conduit.

16. The mushroom cultivation rack as claimed in claim 15, wherein the spanning members are suitable for receiving support members for supporting at least one medium conduit, which support members are embodied as a profile.

17. The mushroom cultivation rack as claimed in claim 1, wherein the spanning members comprise engaging means for engaging thereon of a clamp for holding at least one medium conduit and/or support members in upward orientation.

18. The mushroom cultivation rack as claimed in claim 1, wherein the girders are provided with throughfeed channels or slots for feeding therethrough or arranging therein what is an underside of the spanning members during use.

19. The mushroom cultivation rack as claimed in claim 1, wherein the girders are provided with a hook for hooking onto a docking of the uprights, which hook and/or docking are manufactured by means of a shearing operation from the base material.

20. The mushroom cultivation rack as claimed in claim 9, wherein the coating of the material of the side panels is manufactured so as to withstand a wear load from the machines.

21. A method for using a mushroom cultivation rack as claimed in claim 1, comprising:
providing the mushroom cultivation rack,
supplying the substrate to the rack from a side of the rack over a longitudinal direction of the spanning members by means of a suitable transport medium,
performing a substrate-related growing and harvesting cycle making use of the substrate,
discharging the substrate from the rack from a side of the rack over the longitudinal direction of the spanning members by means of a suitable transport medium.

22. A method for manufacturing a mushroom cultivation rack while applying only operations of cutting, shearing, punching and folding, in an automated process while applying a prefabricated sheet material with a metallic alloy as coating.
